(19) United States
(12) Patent Application Publication
(10) Pub. No.: US 2010/0189994 A1
(43) Pub. Date: Jul. 29, 2010

(54) AQUEOUS DISPERSIONS OF CROSS-LINKED, TERTIARY ESTER GROUPS CONTAINING EMULSION POLYMERISATES AND WATER-ABSORBENT MATERIALS ON A CARRIER MATERIAL MADE THEREOF

(75) Inventors: Marc Bothe, Limburgerhof (DE); Hermann Seyffer, Heidelberg (DE); Mirjam Herrlich-Loos, Mannheim (DE); Robert Heger, Hong Kong Kowloon (HK); Matthias Weismantel, Jossgrund (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/376,797

(22) PCT Filed: Aug. 6, 2007
(86) PCT No.: PCT/EP07/58104

§ 371 Date: Feb. 9, 2009

(30) Foreign Application Priority Data
Aug. 17, 2006 (EP) 06119084.9

(51) Int. Cl. B32B 27/04; C09K 3/00; B32B 27/36; B32B 27/06

(52) U.S. Cl. 428/319.3; 252/194; 428/482; 442/118; 428/446

(57) ABSTRACT

Aqueous dispersions of crosslinked emulsion polymers comprising tertiary ester groups, comprising
(a) at least 50% by weight of an ester derived from a tertiary alcohol and an ethylenically unsaturated C₃ to C₅ carboxylic acid,
(b) 0.001% to 5.0% by weight of at least one compound having at least two ethylenically unsaturated double bonds, and
(c) 0% to 49.999% by weight of at least one other monoethylenically unsaturated compound
   in interpolymerized form and having an average particle size of not more than 1000 nm, and water-absorbing materials obtainable by coating a backing material with the aqueous dispersion described of crosslinked emulsion polymers comprising tertiary ester groups, drying and heating the thus treated backing material to a temperature of at least 140° C. to form carboxyl groups from the tertiary ester groups of the emulsion polymer and at least partly neutralizing the carboxyl groups, and also the use of the water-absorbing materials as an absorbent for water and aqueous fluids.

The present invention relates to aqueous dispersions of crosslinked emulsion polymers comprising tertiary ester groups, to water-absorbing materials composed of a water-absorbing polymer and a backing material, and also to the use of the water-absorbing materials to absorb bodily fluids or other aqueous fluids.

Water-absorbing or water-swellable polymers absorb for example at least 25% and preferably at least 100% of their own weight of water. Well known water-absorbing polymers which are also known as superabsorbents and which absorb more than 10 times their weight of water are for example crosslinked polyacrylic acids, graft copolymers of ethylenically unsaturated carboxylic acids on polysaccharides, crosslinked ethers of cellulose or of starch, and crosslinked polyalkylene oxides. Water-absorbing polymers are used for example in diapers, tampons, tissue papers, dressings, sanitary papers, cleaning cloths and packaging papers.

For instance, EP-A-0 437 816 discloses a superabsorbent wet-lay nonwoven material obtained as follows: blending superabsorbent polymer particulates (particle size 0.5 to 450 μm) with a liquid to form a slurry, mixing fibers with the slurry, filtering the mixture of superabsorbent and fibers and then drying to obtain a nonwoven wet-lay superabsorbent material. The material thus obtained is used inter alia in diapers, incontinence articles, packaging papers for food and dressing materials such as plasters.

EP-B-1 068 392 discloses an improved wet process of producing an absorbent structure. It involves utilizing a wet-lay nonwoven apparatus to process a fiber furnish which additionally comprises water-swellable, water-insoluble superabsorbent polymer particles to form a wetted wet-laid web containing superabsorbent polymer particles, draining water from the web and subsequently conveying the web to the dry section of the apparatus. What is decisive for this process is that the contact between superabsorbent and furnish to the time the web passes into the drying section is not more than 45 seconds, so that the superabsorbent does not have sufficient time to swell.

U.S. Pat. No. 5,997,690 and U.S. Pat. No. 6,290,813 B1 disclose a process for the production of wet-laid non-woven superabsorbent material wherein a slurry of water-swellable, water-insoluble superabsorbent particles with fibers is produced. The superabsorbent particles are less than 250 micrometers in particle size before addition to the aqueous slurry of fibers. This slurry is subsequently admixed with a salt-containing solution.

Thereafter, a wet web is formed, washed with water and subsequently dried. The wet-laid non-woven materials thus obtained have a residual salt content of less than 40% in the dry state.

US-A-2002/0060013 discloses a method for producing an absorbent wetlaid paper material containing at least 1% by weight of an absorbent polymer having a thermo-reversible liquid uptake capacity.

US-A-2003/0014038 discloses superabsorbent articles comprising a core of swellable branched superabsorbent particles. The articles disclosed in this reference can be admixed with effective amounts of an antibiotic or of an antibacterial agent, so that the end products can be used in the medical sector.

Prior application PCT/EP2006/062346 discloses a process for producing paper, board and cardboard wherein a fiber suspension comprising for example 0.1% to 20% by weight of water-swellable polymers is beaten and subsequently dewatered on a wire with sheet formation. The materials comprising water-swellable polymers are used for example as tissue papers, hygiene and sanitary papers, packaging papers or for producing multilayered papers.

Furthermore, DE-A-1 811 593 discloses sheetlike constructions capable of reversible uptake of water vapor which are obtainable by a sheetlike construction (a fibrous nonwoven web or a woven fabric) being coated with an aqueous dispersion of a copolymer comprising interpolymerized tert-butyl acrylate, the coated construction then being dried and heated to a temperature of for example 100 to 140° C., which eliminates isobutene from the interpolymerized tert-butyl acrylate and causes the coating to foam up.

The present invention has for its object to provide novel matters from which water-absorbing materials for example are obtainable.

We have found that this object is achieved by aqueous dispersions of crosslinked emulsion polymers comprising tertiary ester groups when the emulsion polymers comprise
(a) at least 50% by weight of an ester derived from a tertiary alcohol and an ethylenically unsaturated C₃ to C₅ carboxylic acid,
(b) 0.001% to 5.0% by weight of at least one compound having at least two ethylenically unsaturated double bonds, and
(c) 0% to 49.999% by weight of at least one other monoethylenically unsaturated compound
   in interpolymerized form and have an average particle size of not more than 1000 nm.

Preference is given to crosslinked emulsion polymers comprising
(a) at least 90% by weight of a tert-butyl ester of an ethylenically unsaturated C₃ to C₅ carboxylic acid,
(b) 0.01% to 2.0% by weight of at least one compound having at least two ethylenically unsaturated double bonds, and
(c) 0% to 49.99% by weight of at least one other monoethylenically unsaturated compound
   in interpolymerized form and have an average particle size of less than 500 nm.

Particular preference is given to such crosslinked emulsion polymers as comprise
(a) 98.0% to 99.99% by weight of at least one tert-butyl ester of an ethylenically unsaturated C₃ to C₅ carboxylic acid and
(b) 0.01% to 2.0% by weight of at least one compound having at least two ethylenically unsaturated double bonds
   in interpolymerized form and have an average particle size in the range from 30 to 400 nm.

The ester monomers of group (a) are preferably derived from tert-butanol or from tert-amyl alcohol (2-methylbutan-2-ol) and ethylenically unsaturated C₃ to C₅ carboxylic acids, such as acrylic acid, methacrylic acid, maleic acid, fumaric acid, itaconic acid, crotonic acid, vinylacetic acid, vinyllactic acid and ethacrylic acid. The ester can be formed using for example a single ethylenically unsaturated carboxylic acid or two or more of such acids. The mixtures of tertiary esters obtained in such a case can then be used in the polymerization as component (a) just like the pure esters. tert-Butyl acrylate is also obtainable for example by addition of isobutene onto acrylic acid. Among this group of monomers, tert-butyl acrylate is preferred.

The monomers of group (a) are incorporated in the emulsion polymers in an amount of at least 50% by weight and preferably at least 90% by weight. The emulsion polymers usually comprise 98.0% to 99.9% by weight of at least one monomer of group (a).

The monomers of group (b) are compounds having at least two ethylenically unsaturated double bonds. These monomers are so-called crosslinkers typically used in the production of water-absorbing polymers (superabsorbents), cf. EP-A-0 858 478 page 4 line 30 to page 5 line 43 and also EP-A-0 547 847, EP-A-0 559 476, EP-A-0 632 068, WO-A-93/21237, WO-A-03/104299, WO-A-03/104300, WO-A-03/104301 and mixtures of crosslinkers known for example from DE-A-195 43 368, DE-A-196 46 484, WO-A-90/15830 and WO-A-02/32962.

Examples of crosslinkers are triallylamine, pentaerythritol triallyl ether, methylenebisacrylamide, N,N′-divinylethyleneurea, at least diallyl ethers or at least divinyl ethers of polyhydric alcohols such as for example sorbitol, 1,2-ethanediol, 1,4-butanediol, trimethylolpropane, glycerol, diethylene glycol and of sugars such as sucrose, glucose, mannose, fully acrylated or methacrylated dihydric alcohols having 2 to 4 carbon atoms such as ethylene glycol dimethacrylate, ethylene glycol diacrylate, butanediol dimethacrylate, butanediol diacrylate, diacrylates or dimethacrylates of polyethylene glycols having molecular weights in the range from 100 to 600, ethoxylated trimethylenepropane triacrylates or ethoxylated trimethylenepropane trimethacrylates, 2,2-bis(hydroxymethyl)butanol trimethacrylate, pentaerythritol triacrylate, pentaerythritol tetraacrylate and triallylmethylammonium chloride. The emulsion polymers preferably comprise allyl methacrylate, 1,4-butanediol diacrylate, divinylbenzene or mixtures thereof in interpolymerized form.

The amounts of interpolymerized crosslinkers present in the emulsion polymers range from 0.001% to 5.0% by weight and preferably from 0.01% to 2.0% by weight.

Particular preference is given to emulsion polymers comprising in interpolymerized form tert-butyl acrylate and/or tert-butyl methacrylate as monomer of group (a) and allyl methacrylate, butanediol diacrylate, divinylbenzene or mixtures thereof as monomer of group (b).

The crosslinked emulsion polymers may if appropriate comprise as monomers of group (c) in interpolymerized form at least one other monoethylenically unsaturated monomer to modify their properties. Examples of such monomers are esters or primary of secondary monohydric alcohols having 1 to 22 carbon atoms and ethylenically unsaturated C₃ to C₅ carboxylic acids (for example methyl acrylate, ethyl acrylate, n-propyl acrylate, isopropyl acrylate, n-butyl acrylate, isobutyl acrylate, methyl methacrylate, ethyl methacrylate, n-propyl methacrylate, isopropyl methacrylate, n-butyl methacrylate, isobutyl methacrylate, dimethyl maleate, diethyl maleate and dimethyl itaconate), styrene, α-methylstyrene, vinylsulfonic acid, vinylphosphonic acid, sulfoethyl acrylate, sulfoethyl methacrylate, 2-acrylamidomethylpropionic acid, styrenesulfonic acid, alkali metal and ammonium salts of the aforementioned acids, acrylamide, methacrylamide, N-vinylformamide, acrylonitrile, methacrylonitrile, N,N-dialkylaminoalkyl (meth)acrylates (for example dimethylaminoethyl acrylate, dimethylaminoethyl methacrylate, dimethylaminopropyl acrylate, dimethylaminopropyl methacrylate, diethylaminoethyl acrylate and diethylaminoethyl methacrylate and also the salts of the basic monomers mentioned with mineral acids or carboxylic acids and also the basic monomers quaternized with alkyl halides or with dimethyl sulfate) and dialkylaminoalkyl(meth)acrylamides such as dimethylaminoethylacrylamide.

The crosslinked emulsion polymers comprise the monomers of group (c) in an amount of 0% to 49.999% by weight in interpolymerized form. When monomers of group (c) are present in the emulsion polymers, their proportion will usually be up to 8% by weight. The practice of free-radically initiated emulsion polymerizations of ethylenically unsaturated monomers in an aqueous medium is described in the literature and therefore sufficiently well known to those skilled in the art [cf. emulsion polymerization in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 bis 142 (1990); Emulsion Polymerisation, Interscience Publishers, New York (1965); DE-A 40 03 422 and Dispersionen synthetischer Hochpolymerer, F. Holscher, Springer-Verlag, Berlin (1969)]. The free-radically induced aqueous emulsion polymerization reactions are typically carried out by the ethylenically unsaturated monomers being dispersed in an aqueous medium in the form of monomer droplets in the presence of dispersing assistants and polymerized by means of a free-radical polymerization initiator.

The emulsion polymers are prepared using dispersing assistants capable of keeping not only the monomer droplets but also the copolymer particles in a dispersed state in the aqueous phase and thus of ensuring the stability of the aqueous copolymer dispersions produced. Useful dispersing assistants include not only the protective colloids typically used for performing free-radical aqueous emulsion polymerizations but also emulsifiers.

Useful protective colloids include for example polyvinyl alcohols, cellulose derivatives or vinylpyrrolidone-containing copolymers. An extensive description of further useful protective colloids is to be found in Houben-Weyl, Methoden der organischen Chemie, volume XIV/1, Makromolekulare Stolle, pages 411 to 420, Georg-Thieme-Verlag, Stuttgart, 1961.

It will be appreciated that mixtures of emulsifiers and/or protective colloids can be used as well. Dispersing assistants frequently used are exclusively emulsifiers whose relative molecular weights, unlike those of protective colloids, are typically below 1000 g/mol. They can be anionic, cationic or nonionic in nature. Where mixtures of surface-active substances are used, the individual components must of course be compatible with one another, something which in the case of doubt can be verified by means of a few preliminary tests. In general, anionic emulsifiers are compatible with anionic emulsifiers and with nonionic emulsifiers. The same holds for cationic emulsifiers, whereas anionic and cationic emulsifiers are usually not compatible with each other.

Customary emulsifiers are for example ethoxylated mono-, di- and tri-alkylphenols (EO degree: 3 to 50, alkyl radical: C₄ to C₁₂), ethoxylated fatty alcohols (EO degree: 3 to 50; alkyl radical: C₈ to C₃₆), and alkali metal salts and ammonium salts of alkyl sulfates (alkyl radical: C₈ to C₁₂), of sulfuric monoesters with ethoxylated alkanols (EO degree: 4 to 30, alkyl radical: C₁₂ to C₁₈) and ethoxylated alkylphenols (EO degree: 3 to 50, alkyl radical: C₄ to C₁₂), of alkylsulfonic acids (alkyl radical: C₁₂ to C₁₈) and of alkylarylsulfonic acids (alkyl radical: C₉ to C₁₈). Further suitable emulsifiers are found in Houben-Weyl, Methoden der organischen Chemie, volume XIV/1, Makromolekulare Stoffe, pages 192 to 208, Georg-Thieme-Verlag, Stuttgart, 1961.

Compounds which have also proven appropriate surface-active substances include those of the general formula I

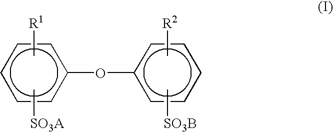

in which R¹ and R² are C₄ to C₂₄ alkyl and where one of the radicals R¹ or R² can also be hydrogen, and A and B can be alkali metal ions and/or ammonium ions. In the general formula I, R¹ and R² are preferably linear or branched alkyl radicals of 6 to 18 C atoms, having in particular 6, 12 and 16 C atoms or H atoms, with R¹ and R² not both simultaneously being H atoms. A and B are preferably sodium, potassium or ammonium ions, sodium ions being particularly preferred. Particularly advantageous compounds I are those in which A and B are sodium ions, R¹ is a branched alkyl radical with 12 C atoms and R² is an H atom or R¹. Use is made frequently of technical grade mixtures containing a fraction of 50% to 90% by weight of the monoalkylated product, an example being Dowfax® 2A1 (brand of the Dow Chemical Company). The compounds I are general knowledge, from U.S. Pat. No. 4,269,749, for example, and are available commercially.

Preference is given to using nonionic and/or anionic dispersing assistants. However, cationic dispersing assistants can also be used. The amount of dispersing assistant used is generally in the range from 0.1% to 5% by weight and preferably in the range from 0.5% to 3% by weight, all based on the total amount of monomer. All or some of the dispersing assistant for example can be included in the initial charge to the polymerization vessel. Any remainder can then be added all at once or together with the monomers in portions or by continuous metering.

The initiation of the free-radically initiated aqueous emulsion polymerization is effected by means of a free-radical polymerization initiator (free-radical initiator). This initiator may in principle encompass not only peroxides but also azo compounds. Redox initiator systems are of course also suitable. Peroxides used may in principle be inorganic peroxides, such as hydrogen peroxide or peroxodisulfates, such as the mono- or di-alkali metal or ammonium salts of peroxodisulfuric acid, such as, for example, its mono- and di-sodium, -potassium or -ammonium salts or organic peroxides, such as alkyl hydroperoxides, examples being tert-butyl, p-menthyl or cumyl hydroperoxide, and also dialkyl or diaryl peroxides, such as di-tert-butyl peroxide or dicumyl peroxide. As an azo compound, use is made substantially of 2,2′-azobis(isobutyronitrile), 2,2′-azobis(2,4-dimethylvaleronitrile) and 2,2′-azobis(amidinopropyl) dihydrochloride (AIBA, corresponding to V-50 from Wako Chemicals). Suitable oxidizing agents for redox initiator systems are essentially the abovementioned peroxides. As corresponding reducing agents it is possible to use compounds of sulfur having a low oxidation state, such as alkali metal sulfites, for example potassium and/or sodium sulfite, alkali metal hydrogen sulfites, for example potassium and/or sodium hydrogen sulfite, alkali metal metabisulfites, for example potassium and/or sodium metabisulfite, formaldehyde sulfoxylates, for example potassium and/or sodium formaldehyde sulfoxylate, alkali metal salts, especially potassium and/or sodium salts, of aliphatic sulfinic acids, and alkali metal hydrogen sulfides, such as potassium and/or sodium hydrogen sulfide, salts of polyvalent metals, such as iron(II) sulfate, iron(II) ammonium sulfate, iron(II) phosphate, enediols, such as dihydroxymaleic acid, benzoin and/or ascorbic acid and also reducing saccharides, such as sorbose, glucose, fructose and/or dihydroxyacetone. In general the amount of free-radical initiator used, based on the total monomer amount, is 0.01% to 5%, preferably 0.1% to 3%, and with particular preference 0.2% to 1.5%, by weight.

It is possible to include a portion or the total amount of free-radical initiator in the initial charge to the polymerization vessel. An alternative option is to meter in the total amount or, if appropriate, remainder of free-radical initiator together with the monomers but separately from them.

The emulsion polymerization can also be carried out using further optional auxiliaries familiar to one skilled in the art, examples being thickeners, defoamers, neutralizing agents, preservatives, chain transfer agents and/or complexing agents.

To optimize the rheology of the aqueous copolymer dispersions obtainable according to the present invention in the course of preparation, handling, storage and application, thickeners or rheology additives are frequently used as a formulation constituent.

A person skilled in the art will be aware of a multiplicity of different thickeners, for example organic thickeners, such as xanthan thickeners, guar thickeners (polysaccharides), carboxymethylcellulose, hydroxyethylcellulose, methylcellulose, hydroxypropylmethylcellulose, ethylhydroxyethylcellulose (cellulose derivatives), alkali-swellable dispersions (acrylate thickeners) or hydrophobically modified, polyether-based polyurethanes (polyurethane thickeners) or inorganic thickeners, such as bentonite, hectorite, smectite, attapulgite (Bentone) and also titanates or zirconates (organometallics).

To control foaming during preparation, handling, storage and application of the aqueous copolymer dispersions obtainable according to the present invention, defoamers are used. Defoamers are familiar to one skilled in the art. They are essentially mineral oils and silicone oil defoamers. Defoamers, especially the highly active silicone-containing ones, must generally be very carefully selected and metered, since they can lead to surface defects (craters, dimples, etc) in the coating. What is essential is that defoamer performance can be further enhanced by adding very finely divided hydrophobic particles, for example hydrophobic silica or wax particles, to the defoamer liquid.

If necessary, acids or bases familiar to one skilled in the art for use as neutralizing agents can be used to adjust the pH of the aqueous copolymer dispersions obtainable according to the present invention.

To avoid infestation by microorganisms of the aqueous copolymer dispersions obtainable according to the present invention, in the course of preparation, handling, storage and application, examples of such microorganisms being bacteria, molds, fungi or yeasts, it is common to use biocides or preservatives familiar to one skilled in the art. Especially combinations of actives such as methyl- and chloroisothiazolinones, benzisothiazolinones, formaldehyde and formaldehyde-detaching agents are used in this context.

As well as the aforementioned components, the aqueous copolymer dispersions can optionally also be produced using chain transfer agents in order to reduce or police the molecular weight of the copolymers available through the polymerization. Compounds employed in this context are, essentially, aliphatic and/or araliphatic halogen compounds, such as n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide; organic thio compounds, such as primary, secondary or tertiary aliphatic thiols, such as ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as 2-hydroxyethanethiol, aromatic thiols, such as benzenethiol, ortho-, meta-, or para-methylbenzenethiol, and also all further sulfur compounds described in Polymer Handbook, 3^{rd} edition, 1989, J. Brandrup and E. H. Immergut, John Wiley & Sons, section II, pages 133 to 141; and also aliphatic and/or aromatic aldehydes, such as acetaldehyde, propionaldehyde and/or benzaldehyde; unsaturated fatty acids, such as oleic acid; dienes containing nonconjugated double bonds, such as divinylmethane or vinylcyclohexane; or hydrocarbons containing readily abstractable hydrogen atoms, such as toluene, for example.

The total amount of the further optional auxiliaries, based on the total monomer amount, is generally ≦10%, ≦5%, often ≦3%, and frequently ≦1% by weight.

The total amounts or any remainders of further optional auxiliaries can be added to the polymerization vessel in the course of the polymerization, batchwise in one or more portions or continuously at constant or varying flow rates. In particular, further optional auxiliaries are added during the polymerization continuously at constant flow rates.

Optionally the free-radically initiated aqueous emulsion polymerization can also take place in the presence of a polymer seed, in the presence for example of 0.01% to 10%, frequently of 0.02% to 5% and often of 0.04% to 1.5% by weight of a polymer seed, based in each case on the total monomer amount.

A polymer seed is used particularly when the particle size of the polymer particles to be prepared by means of free-radical aqueous emulsion polymerization is to be set in a controlled way (in this regard see, for example, U.S. Pat. No. 2,520,959 and U.S. Pat. No. 3,397,165).

Use is made in particular of polymer seed whose particles have a narrow size distribution and weight-average diameters D_{w}≦100 nm, frequently ≧5 nm to ≦50 nm and often ≧15 nm to ≦35 nm. Determination of the weight-average particle diameters is known to the skilled worker and is accomplished, for example, via the method of the analytical ultracentrifuge. By weight-average particle diameter in this specification is meant the weight-average D_{w50} value determined by the method of the analytical ultracentrifuge (cf. in this regard S. E. Harding et al., Analytical Ultracentrifugation in Biochemistry and Polymer Science, Royal Society of Chemistry, Cambridge, Great Britain 1992, chapter 10, Analysis of Polymer Dispersions with an Eight-Cell AUC Multiplexer: High Resolution Particle Size Distribution and Density Gradient Techniques, W. Mächtle, pages 147 to 175).

A particle size distribution is considered narrow for the purposes of this specification when the ratio of the weight-average particle diameter D_{w50} to the number-average particle diameter Dₙ₅₀[D_{w50}/Dₙ₅₀] as determined by the method of the analytical ultracentrifuge is ≦2.0, preferably ≦1.5 and more preferably ≦1.2 or ≦1.1.

The polymer seed is typically used in the form of an aqueous polymer dispersion. The aforementioned quantities refer to the polymer solids fraction of the aqueous polymer seed dispersion; they are therefore specified as parts by weight of polymer seed solids, based on the total monomer amount.

Where a polymer seed is used it is advantageous to employ an exogenous polymer seed. Unlike an in situ polymer seed, which is prepared in the reaction vessel before the actual emulsion polymerization is commenced, and which has the same monomeric composition as the polymer prepared by the subsequent free-radically initiated aqueous emulsion polymerization, an exogenous polymer seed is a polymer seed which has been prepared in a separate reaction step and whose monomeric composition differs from that of the polymer prepared by the free-radically initiated aqueous emulsion polymerization, although this means nothing more than that different monomers, or monomer mixtures with a different composition, are used for preparing the exogenous polymer seed and for preparing the aqueous polymer dispersion. The preparation of an exogenous polymer seed is familiar to the skilled worker and is typically accomplished by the introduction as initial charge to a reaction vessel of a relatively small amount of monomers and also a relatively large amount of emulsifiers, and by the addition at reaction temperature of a sufficient amount of polymerization initiator.

It is preferred in accordance with the invention to use an exogenous polymer seed having a glass transition temperature ≧50° C., frequently ≧60° C. or ≧70° C. and often ≧80° C. or ≧90° C. A polystyrene or polymethyl methacrylate polymer seed is particularly preferred. It is possible to include if appropriate a portion or the total amount of exogenous polymer seed as a further optional auxiliary in the initial charge to the polymerization vessel and then to initiate the polymerization. It is also possible, however, to meter in the total amount or any remainders of exogenous polymer seed during the polymerization. The total amount of any remainder of exogenous polymer seed can be added to the polymerization vessel, batchwise in one or more portions or continuously at constant or varying flow rates. Preferably, the total amount of exogenous polymer seed in included in the initial charge.

By polymerization conditions are meant those temperatures and pressures at which the free-radically initiated aqueous emulsion polymerization proceeds at a sufficient polymerization rate. This is dependent in particular on the free-radical initiator used. Advantageously, the nature and amount of the free-radical initiator, the polymerization temperature and the polymerization pressure are selected such that the free-radical initiator has a half life ≦3 hours, with particular advantages ≦1 hour and with very particular advantages ≦30 minutes.

Depending on the free-radical initiator chosen a suitable reaction temperature for the free-radical aqueous emulsion polymerization of the invention is the entire range from 0 to 120° C. It is usual to employ temperatures here of 50 to 100° C., in particular 60 to 95° C. and advantageously 70 to 90° C. The free-radical aqueous emulsion polymerization can be carried out under a pressure of less than, equal to or greater than 1 atm (absolute), so that the polymerization temperature may exceed 100° C. and can be up to 120° C. Where emulsion polymerizations are carried out under subatmospheric pressure, pressures of 950 mbar are set, frequently 900 mbar and often 850 mbar (absolute). With advantage the free-radical aqueous emulsion polymerization is carried out at atmospheric pressure (1 atm or 1.01 bar absolute) under an inert gas atmosphere, such as under nitrogen or argon, for example.

The aqueous reaction medium can in principle additionally comprise small amounts of water-soluble organic solvents such as for example methanol, ethanol, isopropanol, butanols, pentanols, but also acetone etc. Preferably, however, the polymerization is carried out in the absence of organic solvents.

The aqueous polymer dispersion obtained typically has a polymer solids content of ≧10% and ≦70%, frequently ≧20% and ≦65%, and often ≧40% and ≦60%, by weight, based in each case on the aqueous copolymer dispersion. The number-average particle diameter as determined by quasi-elastic light scattering (ISO Standard 13 321; cumulant z-average) is in general between 10 and maximally 1000 nm, frequently between 20 and less than 500 nm and often between 30 and 400 nm.

To reduce the residual monomer content of the aqueous dispersions, they can if appropriate be subjected to a secondary polymerization, for example by adding an initiator or at least two initiators having a different half life to the dispersion after the conclusion of the main polymerization and then heating the mixture to a temperature at which the main polymerization was carried out or which is below or above the temperature maintained during the main polymerization.

The residual monomer content of the aqueous dispersion and also the level of other low boilers can be lowered by chemical and/or physical methods likewise known to one skilled in the art [see for example EP-A 771 328, DE-A 196 24 299, DE-A 196 21 027, DE-A 197 41 184, DE-A 197 41 187, DE-A 198 05 122, DE-A 198 28 183, DE-A 198 39 199, DE-A 198 40 586 and DE-A 198 47 115].

The present invention further provides water-absorbing materials composed of a water-absorbing compound and a backing material, which are obtainable by applying an aqueous dispersion of a crosslinked emulsion polymer comprising
(a) at least 50% by weight of an ester derived from a tertiary alcohol and an ethylenically unsaturated C₃ to C₅ carboxylic acid,
(b) 0.001% to 5.0% by weight of at least one compound having at least two ethylenically unsaturated double bonds, and
(c) 0% to 49.999% by weight of at least one other monoethylenically unsaturated compound
   in interpolymerized form and have an average particle size of not more than 1000 nm, to a backing material, drying and heating the thus treated backing material to a temperature of at least 130° C. to form carboxyl groups from the tertiary ester groups of the emulsion polymer and at least partly neutralizing the carboxyl groups.

The water-absorbing materials are preferably prepared by applying to a backing material a crosslinked emulsion polymer comprising
(a) at least 90% by weight of a tert-butyl ester of an ethylenically unsaturated C₃ to C₅ carboxylic acid ,
(b) 0.01% to 2.0% by eight of at least one compound having at least two ethylenically unsaturated double bonds, and
(c) 0% to 49.99% by weight of at least one other monoethylenically unsaturated compound
   in an interpolymerized form and having an average particle size of not more than 500 nm.

Preferred water-absorbing materials are obtainable by initially coating the backing material with a crosslinked emulsion polymer comprising
(a) 98.0% to 99.99% by weight of at least one tert-butyl ester of an ethylenically unsaturated C₃ to C₅ carboxylic acid and
(b) 0.01% to 2.0% by weight of at least one compound having at least two ethylenically unsaturated double bonds,
   in interpolymerized form and having an average particle size in the range from 30 to 400 nm, thereafter drying the coated backing material, heating to a temperature of at least 130° C. to detach olefins from the crosslinked emulsion polymer to form carboxyl groups and at least partly neutralizing the carboxyl groups. The temperature to which the backing material coated with the crosslinked emulsion polymer is heated is for example in the range from 130 to 250° C., preferably in the range from 140 to 200° C., and mostly in the range from 160 to 190° C. The residence time of the coated backing material under the stated temperature conditions depends on the particular temperature and also on the degree of hydrolysis of the units in the crosslinked emulsion polymer of tertiary ester groups from which the carboxyl groups are formed in the course of the hydrolysis. The residence time is for example in the range from 2 minutes to 5 hours and mostly in the range from 10 minutes to 2 hours. The proportion of tertiary ester groups of the crosslinked polymer which are converted into carboxyl groups is for example in the range from 10% to 100% and preferably in the range from 80 to 95%.

To achieve a very high absorption of water, it is necessary that the carboxyl groups formed from the tertiary ester groups be at least partly neutralized. The degree of neutralization of the carboxyl groups is for example in the range from 50% to 100%, preferably in the range from 70% to 100% and mostly in the range from 80% to 95%. Neutralizing agents include for example an alkali metal and/or ammonium base and/or an alkaline earth metal base. Examples thereof are aqueous sodium hydroxide solution, aqueous potassium hydroxide solution, sodium bicarbonate, sodium carbonate, potassium carbonate, ammonium carbonate, ammonia and amines, preferably ethanolamine, diethanolamine, triethanolamine and morpholine, calcium hydroxide and magnesium oxide. Aqueous sodium hydroxide solution, ethanolamine, diethanolamine and triethanolamine are preferably used as a neutralizing agent.

After the neutralizing step, the water-absorbing material is dried; after drying it comprises for example virtually no water or at most 10% by weight of water. The water content of the dried material is usually below 5% by weight.

The water-absorbing materials are preferably prepared proceeding from a crosslinked emulsion polymer comprising in interpolymerized form tert-butyl acrylate and/or tert-butyl methacrylate as a monomer of group (a) and allyl methacrylate, butanediol diacrylate, divinylbenzene or mixtures thereof as a monomer of group (b).

The concentration of crosslinked emulsion polymer in the aqueous dispersions with which backing materials are treated to form the water-absorbing materials is for example in the range from 5% to 30% by weight and preferably in the range from 10% to 25% by weight. However, it is also possible to use finish solutions having a lower or higher content of emulsion polymer. The amount of crosslinked emulsion polymer applied to the backing material is for example in the range from 5% to 500% by weight and preferably in the range from 30% to 300% by weight, based on backing material.

The backing material is preferably selected from the group consisting of paper, board, cardboard, nonwoven web, woven fabric, knit fabric, silica gel, silicates, mineral building materials, foams composed of melamine-formaldehyde resins and foams composed of polyurethanes.

The above-described treatment of a backing material with at least one partially neutralized polymer gives water-absorbing materials. They are used as absorbents for water and aqueous fluids either alone or in absorbent compositions. Within the absorbent composition, the water absorbing materials of the present invention are present in an absorption medium or fixed thereto.

A backing material for receiving the water-absorbing, at least partially neutralized polymers can be for example a fiber matrix consisting of a cellulose fiber mixture (airlaid web, wet laid web) or of synthetic polymer fibers (meltblown web, spunbonded web), or alternatively of a fiber blend of cellulose fibers and synthetic fibers. Open-celled foams or the like can further be used for incorporating the water-absorbing materials.

Alternatively, such an absorbent composition can be the result of fusing two individual layers to form one or, better, a multiplicity of chambers which contain the water-absorbing polymers. In this case, at least one of the two layers should be water pervious. The second layer can be either water pervious or water impervious. The layer material used can be tissues or wovens, closed or open-celled foams, perforated films, elastomers or wovens composed of fiber material. When the absorbent composition consists of a sequence of layers, the layer material should have a pore structure whose pore dimensions are sufficiently small to retain the water-absorbing polymers. The above examples of the construction of the absorbent composition also include laminates composed of at least two layers between which the water-absorbing polymers are installed and fixed.

Furthermore, the absorption medium can consist of a backing material, for example a polymer film, on which the water-absorbing polymers are fixed. The fixing can be effected not only on one side but also on both sides. The backing material can be water pervious or water impervious.

The construction of the present invention's absorbent materials from at least one backing material and water-absorbing polymers is based on numerous fibrous materials used as fibrous network or matrices. The present invention includes not only fibers of natural origin (modified or unmodified) but also synthetic fibers.

Examples of cellulose fibers include cellulose fibers which are customarily used in absorption products, such as fluff pulp and cellulose of the cotton type. It is further possible to use, as backing material, fibers from soft- or hardwoods and also chemical pulp, semichemical pulp, chemothermomechanical pulp (CTMP), pressure ground-wood (PGW), woodpulp, sulfate and sulfite pulp and fibers from recycled paper. Both bleached and unbleached fibers can be used. For instance, natural cellulose fibers such as cotton, flax and jute and also ethylcellulose and cellulose acetate are used. It is also possible to use fibers composed of silk or wool, or sheetlike constructions formed therefrom, as a backing material.

Suitable synthetic fibers are produced for example from polyvinyl chloride, polyvinyl fluoride, polytetrafluoroethylene, polyvinylidene chloride, polyacrylic compounds such as ORLON®, polyvinyl acetate, polyethyl vinyl acetate, soluble or insoluble polyvinyl alcohol. Examples of synthetic fibers include thermoplastic polyolefin fibers, such as polyethylene fibers (PULPEX®), polypropylene fibers and polyethylene-polypropylene bicomponent fibers, polyester fibers, such as polyethylene terephthalate fibers (DACRON® or KODEL®), copolyesters, polyvinyl acetate, polyethyl vinyl acetate, polyvinyl chloride, polyvinylidene chloride, polyacrylics, polyamides, copolyamides, polystyrene and copolymers of the aforementioned polymers and also bicomponent fibers composed of polyethylene terephthalate-polyethylene-isophthalate copolymer, polyethyl vinyl acetate/polypropylene, polyethylene/polyester, polypropylene/polyester, copolyester/polyester, polyamide fibers (nylon), polyurethane fibers, polystyrene fibers and polyacrylonitrile fibers. Preference is given to polyolefin fibers, polyester fibers and their bicomponent fibers. Preference is further given to thermally adhesive bicomponent fibers composed of polyolefin of the core-sheath type and side-by-side type on account of their excellent dimensional stability following fluid absorption.

The natural fibers mentioned are preferably used in combination with thermoplastic fibers. In the course of the heat treatment, the latter migrate to some extent into the matrix of the fiber material present and so constitute bond sites and renewed stiffening elements on cooling. Additionally the addition of thermoplastic fibers means that there is an increase in the present pore dimensions after the heat treatment has taken place. This makes it possible, by continuous addition of thermoplastic fibers during the formation of the absorbent layer, to continuously increase the fraction of thermoplastic fibers in the direction of the topsheet, which results in a similarly continuous increase in the pore sizes. Thermoplastic fibers can be formed from a multiplicity of thermoplastic polymers which have a melting point of less than 190° C., preferably in the range from 75° C. to 175° C. These temperatures are too low for damage to the cellulose fibers to be likely.

Lengths and diameters of the above-described synthetic fibers are not restricted, and generally any fiber from, say, 1 to 200 mm in length and from 0.1 to 100 denier (gram per 9000 meters) in diameter may preferably be used. Preferred thermoplastic fibers are from 3 to 50 mm in length, particularly preferred thermoplastic fibers are from 6 to 12 mm in length. The preferred diameter for the thermoplastic fiber is in the range from 1.4 to 10 decitex, and the range from 1.7 to 3.3 decitex (gram per 10 000 meters) is particularly preferred. The form of the fiber may vary; examples include woven types, narrow cylindrical types, cut/chopped yarn types, staple fiber types and continuous filament fiber types.

The fibers in the water-absorbing composition of the present invention can be hydrophilic, hydrophobic or a combination thereof. According to the definition of Robert F. Gould in the 1964 American Chemical Society publication “Contact angle, wettability and adhesion”, a fiber is referred to as hydrophilic when the contact angle between the liquid and the fiber (or the fiber surface) is less than 90° or when the liquid tends to spread spontaneously on the same surface. The two processes are generally coexistent. Conversely, a fiber is termed hydrophobic when a contact angle of greater than 90° is formed and no spreading is observed.

Preference is given to using hydrophilic fiber material. Particular preference is given to using fiber material which is weakly hydrophilic on the body side and most hydrophilic in the region surrounding the highly swellable hydrogels. In the manufacturing process, layers having different hydrophilicities are used to create a gradient which channels impinging fluid to the water-absorbing polymer material, where it is ultimately absorbed.

Suitable hydrophilic fibers for use in the absorbent composition of the present invention include for example cellulose fibers, modified cellulose fibers, rayon, polyester fibers, for example polyethylene terephthalate (DACRON®), and hydrophilic nylon (HYDROFIL®). Suitable hydrophilic fibers may also be obtained by hydrophilicizing hydrophobic fibers, for example the treatment of thermoplastic fibers obtained from polyolefins (e.g. polyethylene or polypropylene, polyamides, polystyrenes, polyurethanes, etc.) with surfactants or silica. However, for cost reasons and ease of availability, cellulosic fibers are preferred.

The fluid-acquiring and -distributing fiber matrix may comprise synthetic fiber or cellulosic fiber or a mixture of synthetic fiber and cellulosic fiber, in which case the mixing ratio may vary from (100 to 0) synthetic fiber: (0 to 100) cellulosic fiber. The cellulosic fibers used may additionally have been chemically stiffened to increase the dimensional stability of the absorbing composition.

The chemical stiffening of cellulosic fibers may be provided in different ways. A first way of providing fiber stiffening is by adding suitable coatings to the fiber material.

Such additives include for example polyamide-epichlorohydrin coatings (Kymene® 557H, Hercoles, Inc. Wilmington, Del.), polyacrylamide coatings (described in U.S. Pat. No. 3,556,932 or as the Parez® 631 NC commercial product from American Cyanamid Co., Stamford, Conn.), melamine-formaldehyde coatings and polyethyleneimine coatings.

Cellulosic fibers may also be chemically stiffened by chemical reaction. For instance, suitable crosslinker substances may be added to effect crosslinking taking place within the fiber. Suitable crosslinker substances are typical substances used for crosslinking monomers including but not limited to C₂-C₈-dialdehydes, C₂-C₈-monoaldehydes having acid functionality and in particular C₂-C₉-polycarboxylic acids. Specific substances from this series are for example glutaraldehyde, glyoxal, glyoxylic acid, formaldehyde and citric acid. These substances react with at least 2 hydroxyl groups within any one cellulose chain or between two adjacent cellulose chains within any one cellulose fiber. The crosslinking causes a stiffening of the fibers, to which greater dimensional stability is imparted as a result of this treatment. In addition to their hydrophilic character, these fibers exhibit uniform combinations of stiffening and elasticity. This physical property makes it possible to retain the capillary structure even under simultaneous contact with fluid and compressive forces and to prevent premature collapse.

Chemically crosslinked cellulosic fibers are known and described in WO 91/11162, U.S. Pat. No. 3,224,926, U.S. Pat. No. 3,440,135, U.S. Pat. No. 3,932,209, U.S. Pat. No. 4,035,147, U.S. Pat. No. 4,822,453, U.S. Pat. No. 4,888,093, U.S. Pat. No. 4,898,642 and U.S. Pat. No. 5,137,537. The chemical crosslinking imparts stiffening to the fiber material, and this is ultimately reflected in improved dimensional stability for the absorbent composition. Chemically crosslinked cellulosic fibers are admittedly somewhat more hydrophobic than untreated cellulosic fibers, but since the use of crosslinked cellulosic fibers in the absorbent composition of the present invention is intended, owing to the high proportion of absorbent component, for fluid transportation only and not for fluid storage or buffering, the hydrophobicization has no adverse effects whatsoever on the absorption profile. The individual layers are joined together by methods known to one skilled in the art, for example intermelting by heat treatment, addition of hot-melt adhesives, latex binders, etc.

Useful backing materials further include all styles of paper, for example papers for newsprint, so-called medium fine writing and printing papers, natural gravure printing papers and lightweight coating base papers and also paperboard and cardboard, single-layer/multilayer folding boxboard, single-layer/multilayer liner, corrugate. To produce such papers, it is possible to proceed for example from groundwood, thermomechanical pulp (TMP), chemothermomechanical pulp (CTMP), pressure groundwood (PGW), mechanical pulp, sulfite and sulfate pulp and also from fibers recovered from recycled paper. It is possible to use not only the pure paper stocks but also mixtures of two or more paper stocks, in particular fibers from recycled paper content fiber mixtures for producing suitable backing materials. The chemical pulps may be both short-fiber and long-fiber. The dispersions of crosslinked emulsion polymers are preferably applied to paper and paper products one- or both-sidedly. However, they can also be added to the fiber in the course of papermaking, prior to sheet formation.

The water-absorbing materials of the present invention can be used in all sectors concerned with rapid and permanent binding of aqueous fluids. Examples of such applications comprise industrial applications and also hygiene applications. Illustrative non-limiting applications include:—
market gardening
medicine (wound plasters, water-absorbing material for burn dressings or other weeping wounds, quick dressings for injuries, quick absorption of exuding bodily fluids for later analytical and diagnostic purposes), carrier material for pharmachemicals and medicaments, rheumatic plasters, ultrasonic gel, cooling gel
cosmetics, cosmetic thickeners, sunscreen
thickeners for oil/water or water/oil emulsions textile (gloves, sportswear, moisture regulation in textiles, shoe inserts, synthetic wovens)
hydrophilicization of hydrophobic surfaces; pore formation
chemical process industry applications (catalyst for organic reactions, immobilization of large functional molecules (enzymes), heat storage media, filtration aids, hydrophilic component in polymer laminates, dispersants, superplasticizers)
building and construction (sealing compositions; systems or to be more precise films that self seal in the presence of moisture; fine pore formers in sintering building materials or ceramics; self-sealing insulation for water-conducting pipework or for buried pipework; sealing of building materials in soil by the water-absorbing material swelling with a time delay in the moist soil and thus effecting a cut-out or seal; finishing of carpets and carpeting), insulation, vibration-inhibiting medium, assistants in relation to tunneling in water-rich ground, assistants in relation to excavations and drilling in water-rich ground, cable sheathing
fire protection
coextrusion agent in thermoplastic polymers; production of films and thermoplastic moldings capable of absorbing water (for example agricultural films capable of storing rain and dew water; SAP-containing films for keeping fruit and vegetables fresh which can be packed in moist films to avoid rottling and wilting); coextrudates of water-absorbing materials with polystyrene for example
carrier substance in active ingredient formulations (pharma, crop protection)
agricultural industry: protection of forests against fungal/insect infestation, delayed release of active ingredients to plants)

The water-absorbing materials are preferably used in the form of an absorbent composition. The preferred fields of use for the water-absorbing materials of the present invention in the industrial sector and in hygiene are for example the use as wipes, paper cloths, pads, cushions, in absorbent products in the medical sector and also in absorbent products in the home and in industry.

One aspect of using the water-absorbing materials in accordance with the present invention concerns the use in wipes. The field of use of the water-absorbing materials in relation to wipes comprises wipes for cleaning purposes, as for example in moistened cleaning sponges for cleaning floors, or generally for removing dirt from surfaces. The main field of use of wipes comprises industry, the home and hygiene, in particular baby care. Examples include industrial wipes, abrasive cloths and swatches, moistening cloths, household cloths (for removing oil, water, biological fluids), wipes in the food sector (food service), dishware wipes, wipes for automotive care, also wipes for cleaning hard surfaces, as for example glass surfaces, kitchen, furniture, bath; wipes in the industrial cleaning of hard surfaces of any kind, wipes for removing chemical contaminations or impurities; also wipes for personal care applications, as for example skin and face cleaning, application and removal of cosmetics, hair rinses, setting agents and/or medicinal products for skin health care; wipes for cleaning and/or treating clothing and textiles; wipes for infant care, such as for example bibs, diapers, and for use in preventative health care, as for example bandages, antimicrobial hygiene cloths.

A second aspect of the use of the water-absorbing materials in accordance with the present invention concerns use in paper cloths. Examples thereof comprise face cloths, cleaning cloths, towels, paper towels, travel towels, and also absorbent paper products. The paper cloths are used for improving skincare and also for removing dirt, microbes, bacteria of any kind, fungi (yeast and mold fungi), protozoae, viruses and also other substances from the skin surface. Paper cloths also find use in fresh meat/fresh fish trays for absorbing the flesh juice.

A third aspect of the use of the water-absorbing materials in accordance with the present invention concerns the use in pads/cushions. Examples thereof comprise abrasive pads, polishing pads, sanding pads, generally cleaning pads (cottonwool) for personal and wound care, as for example for absorbing perspiration, menses, as an underlay for changing the hygiene article, use in bed covers, shoe inserts, in padding and also in textiles, as for example underarm pads for sweat absorption, panty liners for absorbing menses.

A fourth aspect of the use of the water-absorbing materials in accordance with the present invention concerns the use in absorbent products in the medical sector.

Examples thereof comprise medical clothing (disease management medicine, surgery), such as for example surgical robes/gowns, disposable clothing, head coverings, gloves, face masks; articles for wound management and care, as for example wound cloths, wound coverings, bandages, (waste) containers, filters, rolled nonwoven articles (in medicine/dentistry); further, absorbent bed underlays, medical cloths/wovens, medical underlays, and also as an absorbent product for medical or dental treatments.

A fifth aspect of the use of the water-absorbing materials in accordance with the present invention relates to the use in absorbent products in the home and in industry. Examples thereof comprise engineering and packaging equipment, products for cleaning and disinfection, cloths, coverings, filters, hand towels, disposable cutting underlays, bathroom towels, facecloths; household goods, such as for example cushions, pads and skincare products, as for example masks, products for skin and face care, textiles, such as for example lab coats, coverings; further, use in the refuse bag, as a stain remover, topical compositions, soiled laundry dirt/ink remover; for agglomerating surfactants; and as separators of lipophilic fluids.

Further optional uses for the water-absorbing materials in accordance with the present invention are: use in tablecloths, surgical drapes, bandages, in absorbent compositions for installation in hygiene articles, such as for example in diapers, in feminine hygiene and adult incontinence. The water-absorbing materials find further use in floor mats, such as for example in the kitchen for absorbing aqueous fluids, in garages for absorbing hydrophobic fluids, as shoe inserts, boot inserts. It can similarly be used in indoor and outdoor applications, in workshops, vehicles, offices, in areas surrounding automatic dispensers (automatic drink dispensers), refrigerators, as thawing aid underneath thawing foods, in restaurants, schools, supply facilities, accident and emergency departments, sport and fitness studios, showers, hospitals. They are further useful for taking up leaked or spilt fluids, such as for example in industry, for use as floor or door mats for wet/damp/dirty shoes, pets, umbrellas, snow, etc; as protective covers for car seats, carpet savers, trunk floor covers; under children's highchairs, under chairs/tables where someone is doing handicrafts or playing, as an underlay when changing diapers, in front of or underneath sinks or basins, in front of or underneath devices which may leak or overflow, in the fridge as a compartment base underlay or underneath thawing products (meat, fish, vegetables); underneath the food preparation area; underneath oil-containing products in the storage room; in the garage, to absorb oil, gasoline and leaked or spilt liquids; under green plants in the home, underneath pets' feeding and water bowls, underneath waste receptacles, as floor mats in pet cages, as a throw or covering of bed covers or as an underlay in the case of incontinence; to take up spilt liquids and clean the soiled areas; as bathroom mats; as mats around the toilet area; in stadia (covering, seat protection) to protect against wetness and for insulation, disposable drink mats or place mats; in food/drink facilities; as a tripod. Further possible uses are bed mats, filter underlays (air filter bags, antibacterial protective filter), filtering materials for removing moisture from nonaqueous filtrates. In hygiene service, the absorbent compositions of the present invention further find use in hygiene articles, such as for example diapers or training pants, or for detection of moisture, wetness and/or biological fluids and/or chemical fluids in the absorbent structure; as packaging materials; as water-retaining or water-sealing agents.

The water-absorbing materials of the present invention are further used together with fabriclike nonwoven materials, with agricultural substrates, in coverings and food packaging.

### EXAMPLES

The average particle diameter of the polymer particles was generally determined by dynamic light scattering on a 0.01 percent by weight aqueous dispersion at 23° C. using an Autosizer IIC from Malvern Instruments, England. The average diameter of the cumulant analysis (cumulant z-average) of the autocorrelation function measured (ISO standard 13321) is reported.

### Production of Dispersions

### Example 1

A mixture of 313.1 g of deionized water and 9.1 g of a 33% by weight aqueous polymer latex (prepared by free-radically initiated emulsion polymerization of styrene) having a weight average particle diameter D_{W50} of 30 nm was heated to 80° C. under nitrogen in a 2 l polymerization reactor equipped with leaf stirrer and heating/cooling means. 8.0 g of a 7% by weight aqueous solution of sodium peroxodisulfate were added at 80° C. After 5 min, feed 1 and feed 2 were commenced. Feed 1 and feed 2 were added at a uniform rate over 3 h.

Feed 1 was an aqueous emulsion prepared from

| | |
|---|---|
| 394.4 g | of deionized water |
| 26.8 g | of a 28% by weight aqueous solution of the sodium |
| | salt of a fatty alcohol ether sulfate with C12-C14- |
| | alkyl radical and a degree of ethoxylation of 3-5 |
| | (Texapon ® NSO from Cognis) |
| 748.1 g | of tert-butyl acrylate |
| 1.9 g | of allyl methacrylate |

Feed 2 consisted of 24.1 g of a 7% by weight aqueous solution of sodium peroxodisulfate.

On completion of feeds 2 and 3, the reaction mixture was stirred at 80° C. for one hour and then cooled down to room temperature. The aqueous polymer dispersion obtained had an average particle size of 208 nm.

### Example 2

Example 1 was repeated except that feed 1 contained 746.3 g of tert-butyl acrylate and 3.8 g of allyl methacrylate.

The aqueous polymer dispersion obtained had an average particle size of 206 nm.

### Example 3

Example 1 was repeated except that feed 1 contained 742.5 g of tert-butyl acrylate and 7.5 g of allyl methacrylate.

The aqueous polymer dispersion obtained had an average particle size of 207 nm.

### Example 4

Example 1 was repeated except that feed 1 contained 749.3 g of tert-butyl acrylate and 0.8 g of allyl methacrylate.

The aqueous polymer dispersion obtained had an average particle size of 209 nm.

### Example 5

Example 1 was repeated except that the initial charge in the reactor contained 2.3 g of a 33% by weight aqueous polymer latex (prepared by free-radically initiated emulsion polymerization of styrene) having a weight average particle diameter DW50 of 30 nm.

The aqueous polymer dispersion obtained had an average particle size of 277 nm. Production and swelling of water-absorbing materials

### Comparative Example 1

To be able to attribute the weight increase of the water-absorbing materials produced according to the present invention when they absorb water to the crosslinked polymer mounted onto the underlay, a strip of filter paper 8×3 cm in size (weight 0.24 g) was heated in air at 140° C. for 5 h, then dipped into a 5% by weight aqueous sodium hydroxide solution for 10 sec and then air dried. The weight continued to be 0.24 g. Following immersion in completely ion-free water, a drip dry weight of 0.54 g resulted after 10 sec or longer.

### Example 6

A strip of filter paper 8×3 cm in size (weight 0.23 g) was dipped in Example 1 dispersion, diluted with water in a volume ratio of 1:1, for 10 sec and subsequently air dried. The dried sample had a weight of 0.35 g. It was heated at 140° C. in air for 5 h, causing its weight to decrease to 0.30 g. The sample material was then dipped for 10 sec into a 5% by weight aqueous sodium hydroxide solution and subsequently air dried. The air-dry water-absorbing material had a weight of 0.35 g. The swelling by immersion in completely ion-free water resulted in a weight increase to 0.88 g after 5 sec and to 1.76 g after 120 sec.

### Example 7

A strip of filter paper 8×3 cm in size (weight 0.24 g) was dipped in Example 2 dispersion, diluted with water in a volume ratio of 1:1, for 10 sec and subsequently air dried. The dried sample had a weight of 0.38 g. It was heated at 140° C. in air for 5 h, causing its weight to decrease to 0.34 g. The sample material was then dipped for 20 sec into a 5% by weight aqueous ammonia solution and subsequently air dried. The air-dry water-absorbing material had a weight of 0.35 g. The swelling by immersion in completely ion-free water resulted in a weight increase to 1.88 g after 60 sec.

### Example 8

A strip of filter paper 8×3 cm in size (weight 0.24 g) was dipped in Example 3 dispersion, diluted with water in a volume ratio of 1:1, for 10 sec and subsequently air dried. The dried sample had a weight of 0.38 g. It was heated at 140° C. in air for 5 h, causing its weight to decrease to 0.34 g. The sample material was then dipped for 10 sec into a 5% by weight aqueous sodium hydroxide solution and subsequently air dried. The air-dry water-absorbing material had a weight of 0.4 g. The swelling by immersion in completely ion-free water resulted in a weight increase to 1.45 g after 120 sec.

### Example 9

A strip of filter paper 8×3 cm in size (weight 0.23 g) was dipped in Example 1 dispersion, diluted with water in a volume ratio of 1:1, for 10 sec and subsequently air dried. The dried sample had a weight of 0.37 g. It was heated at 160° C. in air for 17 min, causing its weight to decrease to 0.32 g. The sample material was then dipped for 10 sec into a 5% by weight aqueous sodium hydroxide solution and subsequently air dried. The air-dry water-absorbing material had a weight of 0.38 g. The swelling by immersion in completely ion-free water resulted in a weight increase to 1.05 g after 10 sec.

### Example 10

A strip of filter paper 8×3 cm in size (weight 0.23 g) was dipped in Example 1 dispersion, diluted with water in a volume ratio of 1:1, for 10 sec and subsequently air dried. The dried sample had a weight of 0.37 g. It was heated at 180° C. in air for 16 min, causing its weight to decrease to 0.31 g. The sample material was then dipped for 10 sec into a 5% by weight aqueous sodium hydroxide solution and subsequently air dried. The air-dry water-absorbing material had a weight of 0.38 g. The swelling by immersion in completely ion-free water resulted in a weight increase to 1.14 g after 10 sec.

### Example 11

A strip of filter paper 8×3 cm in size (weight 0.24 g) was dipped in Example 4 dispersion, diluted with water in a volume ratio of 1:1, for 10 sec and subsequently air dried. The dried sample had a weight of 0.38 g. It was heated at 140° C. in air for 5 h, causing its weight to decrease to 0.33 g. The sample material was then dipped for 10 sec into a 5% by weight aqueous sodium hydroxide solution and subsequently air dried. The air-dry water-absorbing material had a weight of 0.36 g. The swelling by immersion in completely ion-free water resulted in a weight increase to 1.13 g after 10 sec and to 1.73 g after 60 sec.

### Example 12

A strip of filter paper 8×3 cm in size (weight 0.24 g) was dipped in Example 5 dispersion, diluted with water in a volume ratio of 1:1, for 10 sec and subsequently air dried. The dried sample had a weight of 0.39 g. It was heated at 140° C. in air for 5 h, causing its weight to decrease to 0.36 g. The sample material was then dipped for 10 sec into a 5% by weight aqueous sodium hydroxide solution and subsequently air dried. The air-dry water-absorbing material had a weight of 0.38 g. The swelling by immersion in completely ion-free water resulted in a weight increase to 0.86 g after 10 sec and to 1.11 g after 60 sec.

### Example 13

A fibrous nonwoven cellulose web (a Johnson & Johnson bebe young care face cleaning cloth freed of actives by repeated washing with water) 11×8.5 cm in size (weight 0.45 g) was dipped in Example 1 dispersion, diluted with water in a volume ratio of 1:1, for 10 sec and subsequently air dried. The dried sample had a weight of 1.39 g. It was heated at 140° C. in air for 5 h, causing its weight to decrease to 1.00 g. The sample material was then dipped for 30 sec into a 5% by weight aqueous solution of triethanolamine and subsequently air dried. The air-dry water-absorbing material had a weight of 2.10 g. The swelling by immersion in completely ion-free water resulted in a weight increase to 19.43 g after 60 sec.

### Example 14

A strip of filter paper 8×3 cm in size (weight 0.23 g) was dipped in Example 1 dispersion, diluted with water in a volume ratio of 1:1, for 10 sec and subsequently air dried. The dried sample had a weight of 0.36 g. It was heated at 140° C. in air for 5 h, causing its weight to decrease to 0.31 g. The sample material was then dipped for 10 sec into a 5% by weight aqueous solution of triethanolamine and subsequently air dried. The air-dry water-absorbing material had a weight of 0.34 g. The swelling by immersion in completely ion-free water resulted in a weight increase of 1.02 g after 5 sec.

### Example 15

A strip of filter paper 8×3 cm in size (weight 0.23 g) was dipped in Example 1 dispersion, diluted with water in a volume ratio of 1:1, for 10 sec and subsequently air dried. The dried sample had a weight of 0.35 g. It was heated at 140° C. in air for 5 h, causing its weight to decrease to 0.29 g. The sample material was then dipped for 10 sec into a 10% by weight aqueous solution of triethanolamine and subsequently air dried. The air-dry water-absorbing material had a weight of 0.57 g. The swelling by immersion in completely ion-free water resulted in a weight increase to 2.76 g after 20 sec.

1. An aqueous dispersion of crosslinked emulsion polymers comprising tertiary ester groups, wherein the emulsion polymers comprise
(a) at least 50% by weight of a tertiary alcohol ester of an ethylenically unsaturated C₃ to C₅ carboxylic acid,
(b) 0.001% to 5.0% by weight of at least one compound having at least two ethylenically unsaturated double bonds, and
(c) 0% to 49.999% by weight of at least one other monoethylenically unsaturated compound
in interpolymerized form and have an average particle size of not more than 1000 nm.

2. The aqueous dispersion according to claim 1, wherein the emulsion polymers comprise
(a) at least 90% by weight of a tert-butyl ester of an ethylenically unsaturated C₃ to C₅ carboxylic acid,
(b) 0.01% to 2.0% by weight of at least one compound having at least two ethylenically unsaturated double bonds, and
(c) 0% to 49.99% by weight of at least one other monoethylenically unsaturated compound
in interpolymerized form and have an average particle size of less than 500 nm.

3. The aqueous dispersion according to claim 1, wherein the emulsion polymers comprise
(a) 98.0% to 99.99% by weight of at least one tert-butyl ester of an ethylenically unsaturated C₃ to C₅ carboxylic acid and
(b) 0.01% to 2.0% by weight of at least one compound having at least two ethylenically unsaturated double bonds
in interpolymerized form and have an average particle size in the range from 30 to 400 nm.

4. The aqueous dispersion according to claim 1, wherein the emulsion polymers comprise in interpolymerized form at least one selected from the group consisting of tert-butyl acrylate, tert-butyl methacrylate, and a combination thereof as monomer of group (a) and allyl methacrylate, butanediol diacrylate, divinylbenzene or mixtures thereof as monomer of group (b).

5. A water-absorbing material comprising a water-absorbing compound and a backing material obtained by a method comprising:
applying an aqueous dispersion of a crosslinked emulsion polymer comprising
(a) at least 50% by weight of an ester derived from a tertiary alcohol and an ethylenically unsaturated C₃ to C₅ carboxylic acid,
(b) 0.001% to 5.0% by weight of at least one compound having at least two ethylenically unsaturated double bonds, and
(c) 0% to 49.999% by weight of at least one other monoethylenically unsaturated compound
in interpolymerized form and having an average particle size of not more than 1000 nm, to a backing material;
drying and heating the treated backing material to a temperature of at least 130° C. to form carboxyl groups from the tertiary ester groups of the emulsion polymer; and
at least partly neutralizing the carboxyl groups.

6. The water-absorbing material according to claim 5, wherein the crosslinked emulsion polymer comprises
(a) at least 90% by weight of a tert-butyl ester of an ethylenically unsaturated C₃ to C₅ carboxylic acid,
(b) 0.01% to 2.0% by weight of at least one compound having at least two ethylenically unsaturated double bonds, and
(c) 0% to 49.99% by weight of at least one other monoethylenically unsaturated compound
in interpolymerized form and have an average particle size of not more than 500 nm.

7. The water-absorbing material according to claim 5, wherein the crosslinked emulsion polymer comprises
(a) 98.0% to 99.99% by weight of at least one tert-butyl ester of an ethylenically unsaturated C₃ to C₅ carboxylic acid and
(b) 0.01% to 2.0% by weight of at least one compound having at least two ethylenically unsaturated double bonds
in interpolymerized form and has an average particle size in the range from 30 to 400 nm.

8. The water-absorbing material according to claim 5, wherein the crosslinked emulsion polymer comprises in interpolymerized form tert-butyl acrylate and/or tert-butyl methacrylate as monomer of group (a) and allyl methacrylate, butanediol diacrylate, divinylbenzene or mixtures thereof as monomer of group (b).

9. The water-absorbing material according to claim 5, wherein the backing material treated with a crosslinked emulsion polymer is heated to a temperature in the range from 140 to 220° C.

10. The water-absorbing material according to claim 5, wherein 10% to 100% of the tertiary ester groups of the crosslinked emulsion polymer are converted into carboxyl groups.

11. The water-absorbing material according to claim 5, wherein the amount of crosslinked emulsion polymer applied to the backing material is in the range from 5% to 500% by weight, based on backing material.

12. The water-absorbing material according to claim 5, wherein the amount of crosslinked emulsion polymer applied to the backing material is in the range from 30% to 300% by weight, based on backing material.

13. The water-absorbing material according to claim 5, wherein the backing material is selected from the group consisting of paper, board, cardboard, nonwoven web, woven fabric, knit fabric, silica gel, silicates, mineral building materials, foams comprising melamine-formaldehyde resins and foams comprising polyurethanes.

14-18. (canceled)

19. An absorbent composition comprising the water-absorbing material according to claim 5.

20. A hygiene application comprising the water-absorbing material according to claim 5.

21. The water-absorbing material according to claim 5, in the form of a wipe, a paper cloth, a pad, a cushion, a medicinal absorbent product, a home absorbent product, or an industrial absorbent product.
